(19) United States
(12) Patent Application Publication
(10) Pub. No.: US 2007/0192121 A1
(43) Pub. Date: Aug. 16, 2007

(54) Method, system, and computer program product for honoring customer privacy and preferences

(75) Inventor: Nicholas K. Routson, Phoenix, AZ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc. a New York Corporation

(21) Appl. No.: 11/529,365

(22) Filed: Sep. 29, 2006

Related U.S. Application Data
(60) Provisional application No. 60/722,037, filed on Sep. 30, 2005.

(51) Int. Cl. G06Q 10/00; G06Q 30/00

(52) U.S. Cl. 705/1

(57) ABSTRACT

In a business where business units market products or services to customers, a method and system implement customer preferences for customer privacy, customer contact, and other marketing preferences. The method entails creating a centralized customer privacy and preferences storage and processing system, wherein are stored both legal requirements and business policies regarding customer privacy and preferences, and also specific preferences of individual customers. A customer can contact the business through a single point of contact, and using a standardized privacy and preferences interface, can specify all aspects of customer preferences regarding privacy and marketing preferences. Business units initiating a marketing process compare a database of potential marketing targets against the centralized customer privacy and preferences storage and processing system, ensuring that the preferences of all potential targets are respected during the implementation and execution of the marketing process.

### CROSS REFERENCE TO RELATED APPLICATIONS

This application claims priority to, and the benefit of, U.S. Provisional Patent Application No. 60/722,037, titled “System and Method for Honoring Customer Privacy and Preferences,” filed Sep. 30, 2005, which is hereby incorporated by reference in its entirety.

### BACKGROUND OF THE INVENTION

1. Field of the Invention

The present invention is related to managing customer privacy and to managing customer preferences across multiple accounts. More particularly, the present invention is related to ensuring that for every customer, both the customer's privacy and the customer's marketing, contact, and other preferences can be modified conveniently, and maintained consistently, for all accounts owned by the customer. The present invention is further related to ensuring that the customer's preferences are respected in all marketing and other business activities, and further ensuring that the customer's privacy is respected.

2. Related Art

Recently, customer privacy has become a focus of the business world. With regulations creating the federal telemarketing Do Not Call Registry and other Do Not E-mail registries, marketers are now legally constrained in terms of which customers they are permitted to contact, and also in terms of the marketing channels (e.g., e-mail, telephone, facsimile, direct mail, or the like) through which they are permitted to contact the customers. Marketers are also legally constrained with respect to the kinds of information about customers that they are permitted to share, and also the types of organizations with which they may share the customer information. In addition, marketers have recognized that implementing their own policies for respecting customer privacy and related preferences, i.e., policies which may go beyond those required by law, can actually be an important means to improve customer satisfaction and loyalty.

Opt-in/opt-out preferences for customers allow a customer to choose a desired level of communication between the customer and interested businesses. Information sharing preferences allow a customer to determine what types of personal and marketing information may be shared between businesses, or in some cases even between units within a business. Other customer preferences may also influence how a business may interact with a customer, and how customer information may be used. However, these opt-in/opt-out preferences, information sharing preferences, and other customer preferences currently need to be made separately for every account held by the customer, which can be burdensome to the customer.

In addition, large businesses often have multiple services or products, and also have multiple data processing systems to support these services and products, where in many cases these multiple data processing systems are not well integrated. As a result, maintaining consistent and reliable policies for customer privacy and preferences, on a per customer basis, across an entire business enterprise, can be highly problematic.

Given the foregoing, what is needed is a system, method, and computer program product for honoring customer preferences in a way that reduces the burden on the customer and integrates the preferences across all marketing processes and other business processes.

### BRIEF DESCRIPTION OF THE INVENTION

The present invention meets the above-identified needs by providing a system, method, and computer program product for honoring customer privacy and preferences. One embodiment of the present invention provides a centralized customer privacy and preferences (“CP&P”) system. Customers have the ability to exercise preferences across all account relationships with all business units of a business enterprise through one contact point, e.g., a Web portal or a customer service representative. Customer preferences include privacy preferences, understood in the dual sense of how customer information may be shared and also how a customer may be contacted. Customer preferences may also include a diverse range of other options pertaining to other ways in which customer information may be used by the business, and how the business may market to the customer or otherwise interact with the customer.

A centralized CP&P storage system and processing system interfaces with the contact point through a standard input gateway. The centralized CP&P storage system and processing system also interfaces with all marketing processes through a second standard gateway, the standard output gateway. As a result of this architecture and the CP&P processes embodied therein, the one contact point for customer privacy and preferences choices is effectively integrated with back end marketing systems throughout the business enterprise.

Business policies, regulatory policies, and customer preferences of all business units within the business enterprise can be stored at the centralized CP&P system before initial customer contact is made. When customers then contact the enterprise through a contact point, the customers are allowed to easily and confidently exercise their privacy choices regarding how their information is used and/or how they are contacted. In one example, the customers can provide a variety of preferences of, for example, desired types and uses of products, services, and methods of contact.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a flowchart for an example of implementing customer privacy and contact preferences with a financial institution or account issuer, where multiple customer preference capture points may result in a lack of integration for the capture of customer preferences, or a fragmented business contact experience for the customer, or both.

FIG. 2 is an example customer privacy and preferences system having multiple capture points, databases, and marketing processes, where the distribution of customer preferences among multiple databases may result in a lack of integration for the capture of customer preferences, or a lack of consistency or reliability in respecting customer preferences, or a fragmented business contact experience for the customer, or all of the above.

FIG. 3 is a flowchart for a process of implementing customer privacy and preferences in a marketing process in an embodiment of the present invention.

FIG. 4 is an example customer privacy and preference system having a central customer privacy and preference database integrated with all capture points and across all marketing processes in an embodiment of the present invention.

FIG. 5 is an illustration of an example Web interface used for capturing customer privacy and preference information according to an embodiment of the present invention.

FIG. 6 is a flow chart showing how a marketing process can be integrated with the customer privacy and preference system in an embodiment of the present invention.

FIG. 7 is a is a block diagram of a detailed example of a marketing system integrated with a customer privacy and preference system employing an embodiment of the present invention.

FIG. 8 is a block diagram of an exemplary computer system useful for implementing the present invention.

### DETAILED DESCRIPTION

### I. Overview

The present invention is directed to a system, method, and computer program product for implementing customer privacy preferences and other customer preferences. Customer privacy preferences are understood in the dual sense of how the information about a customer, which is recorded and stored by a business or other enterprise, may be shared or otherwise utilized; and also whether a customer may be contacted and how a customer may be contacted for marketing and other business purposes. For example some customers may be willing to have their customer information shared between business units, while other customers may prefer that their customer information remain solely with a business unit with which they currently have a business relationship. Similarly, some customers of a business want their privacy respected in the sense that they want to never be contacted by the business for marketing purposes, while other customers may be receptive to some or all types of marketing campaigns from the business.

Other customer preferences may pertain to various other aspects of the storage, management, communication, and distribution of customer information held by a business or other enterprise, to other aspects of the ways in which a business or other enterprise may market products or services to customers, and to other aspects of how a business or other enterprise interacts with the customers.

The system, method, and computer program product are described herein in the context of business enterprises, business activities, and customer and marketing relations in a business context, and in an embodiment implemented in the context of financial services businesses. The terms “business”, “merchant”, “organization”, and/or “enterprise” may be used interchangeably with each other and shall mean any person, entity, distributor system, software and/or hardware that is a provider, broker and/or any other entity in the distribution chain of goods or services.

It should specifically be understood that the system, method, and computer program product could as well be implemented and applied in contexts other than or in addition to business contexts. For example, the system, method, and computer program product described herein could be implemented by non-profit organizations, not-for-profit organizations, governmental and quasi-governmental organizations, professional organizations, religious organizations, educational institutions, civic organizations, and/or any other organizations which maintain and manage customer or client information, which offer any kind of service or product to customers or clients, or which interact in other ways with customers or clients.

The terms “consumer”, “customer”, “client”, “person”, “individual”, “prospect”, “marketing target”, “potential marketing target”, “target for marketing activity”, “potential target for marketing activity”, and/or the plural form of these terms or phrases are used herein interchangeably throughout to refer to those persons or entities capable of accessing, using, being affected by, being listed in the one or more databases of, purchasing the products of, being clients of, seeking the products and/or services of, being offered products and/or services of, and/or subscribing to or benefiting from the products and/or services of the representative business unit, units, organization, or organizations which would implement and apply the system, method, and computer program product tool that the present invention provides for implementing customer preferences.

This document makes use of the term “capture points”, which are also referred to as both “contact points” and “communications sources”. From the perspective of the customer a “capture point” is a contact point with the business, where the customer may express privacy and contact preferences along with other information the customer may impart to the business. From the perspective of the business or business units within the business, a “capture point” is a point of capture for customer preferences, and therefore also a source which communicates customer preferences to business units, internal databases, and marketing processes.

The present invention is referred to variously as the “method, system, and computer program product for honoring customer privacy and preferences”, the “customer privacy and preferences method”, the “customer privacy and preferences system”, the “customer privacy and preferences process”, the “customer privacy and preferences computer program product”, the “CP&P method”, “the CP&P process”, the “CP&P system”, the “CP&P computer program product”, the “present invention”, the “present method”, or the “present system”, and these terms are used interchangeably throughout this document. A more complete title for the invention would be the “system, method, and computer program product for honoring customer preferences for the privacy, sharing, and usage of customer information, for honoring customer preferences for privacy with respect to being contacted by an organization, and for honoring other customer preferences pertaining to the interaction between the customer and the organization.” The shorter forms listed above are used for obvious reasons of brevity, but should not be understood to limit the invention in any way.

It shall be further understood that terms such as “marketing activity”, “marketing process”, “marketing campaign” and similar terms and phrases used throughout this document refer not only to marketing activity as conventionally understood, e.g., the offer or promotion of products or services to customers, but shall further include, without limitation, the sharing or distribution of customer information within a business or business unit, or with affiliated businesses or organizations.

Similarly, the terms “preference”, “customer preference”, “customer preference for the use of personal information”, or the plural forms thereof, when used without further qualification, shall be understood generally as referring to one or more of the types of preferences discussed above including, for example and without limitation, customer preferences regarding how the information about the customer may be shared, whether the customer may be contacted, how the customer may be contacted, various aspects of the storage, management, communication, and distribution of the customer's information, and other related aspects of how a business, business unit, or other enterprise interacts with the customer or uses the customer's personal information.

The present invention is now described in more detail herein in terms of the above exemplary business context, and typically in the context of a financial business. This is for convenience only and is not intended to limit the application of the present invention. In fact, after reading the following description, it will be apparent to one skilled in the relevant art(s) how to implement the following invention in alternative embodiments, as indicated above. Thus, the description provided below is for purposes of illustration and explanation only, and should not be construed as limiting the scope of the invention. Rather, the scope of the invention is determined by the appended claims.

### II. Consumer Privacy and Preferences Without Centralized Database and Processing

A business's database of customers that are available to receive marketing information can be organized based on how customers are contacted and how customer information is used or shared. For example, the use of spam e-mail controls and “Do Not Call” lists place limits on which customers may be contacted and the manner in which the available customers may be contacted. Also, regulatory controls, such as opt-in and opt-out policies, must be considered. Opt-in legislation, such as that in place in California and Vermont, limits how customer information is used or shared. Under an opt-in scenario, a given activity, such as information sharing or contact, is prohibited unless the consumer expressly permits or consents to such activity. In contrast, under an opt-out scenario, a given activity, such as information sharing or contact, is permitted unless the consumer expressly prohibits such activity.

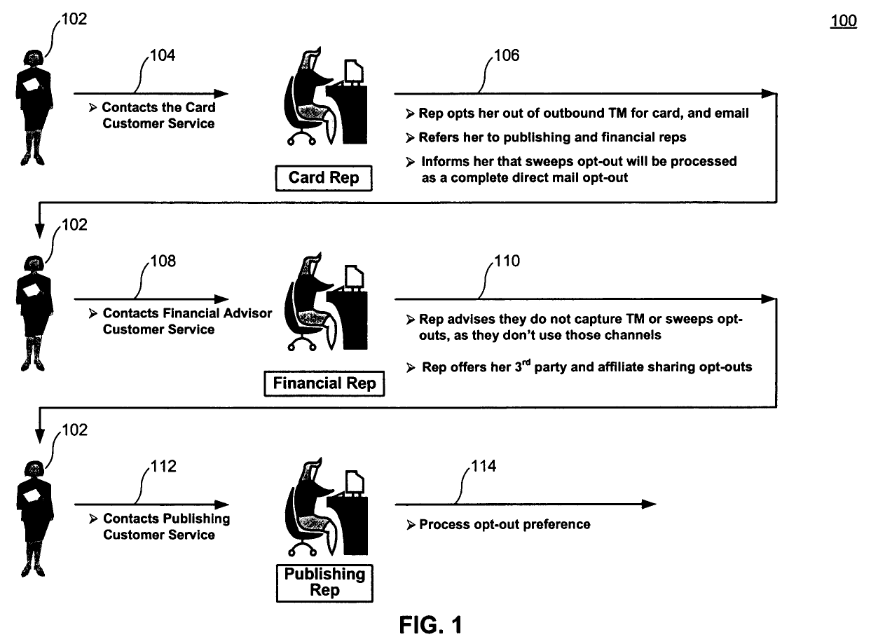

FIG. 1 is an flowchart for an example of implementing customer privacy and contact preferences with a financial institution or account issuer, where multiple customer preference capture points may result in a lack of integration for the capture of customer preferences, or a fragmented business contact experience for the customer, or both. In this example, customer 102 is the customer of a transaction card (e.g., a credit card or charge card) issuer. Customer 102 does not want to be contacted with certain information or offers, for example, sweepstakes offers, and also prefers to be contacted by direct mail instead of e-mail or telephone.

In step 104, customer 102 contacts the transaction card customer service.

In step 106, a transaction card customer service representative is able to opt-out customer 102 from outbound telemarketing and e-mail for the transaction card. However, the transaction card customer service representative may not be able to process the request to opt-out of sweepstakes offers because, for example, sweepstakes offers are controlled by a different business unit. Consequently, the transaction card customer service representative communicates to customer 102 that publishing and financial advisor representatives may handle the sweepstakes opt-outs. The transaction card customer service representative may also inform customer 102 that the sweepstakes opt-out can only be processed as a complete direct mail opt-out. Thus, if customer 102 does not want sweepstakes offers, customer 102 must also forego receiving any other direct mail offers from the transaction card company, which may not be a desirable solution to the customer.

In step 108, customer 102 contacts a financial advisor customer service representative. In step 110, the financial advisor representative communicates to customer 102 that they do not handle telemarketing or sweepstakes opt-outs because telemarketing and sweepstakes operations are not performed by the financial advisor representatives. In one example, the financial advisor representative may communicate to customer 102 that the representative can provide customer 102 with third-party and affiliate sharing opt-outs. However, this may not meet the needs of customer 102.

In step 112, customer 102 contacts a publishing customer service representative. In step 114, the publishing service representative processes the sweepstakes opt-out preference.

In the scenario described in FIG. 1, customer 102 wanted to make only one request to opt out of sweepstakes offers, telemarketing, and e-mail with complete confidence that her request would be fulfilled. Instead customer 102 needed to communicate with several departments regarding being opted-out entirely from direct mail, telemarketing, and e-mail related to the account issuing company, and in the end was left with some doubt that her request would be fulfilled. These types of scenarios result in the customers experiencing significant restrictions regarding their ability to establish their privacy and marketing preferences as they would like, and further provide the customer with a fragmented customer service experience.

Further, in the sample scenario just described, there is a limited ability on the part of the account issuing company to precisely honor the customer request. This is because the account issuing company has multiple capture points, databases, and marketing processes for different customer privacy and preference data. This can result in over-suppression by the customer, decreased customer and brand loyalty for the account issuing company, lost opportunity and revenue to the account issuing company, and a risk of governmental fines due to lack of regulatory compliance by the account issuing company.

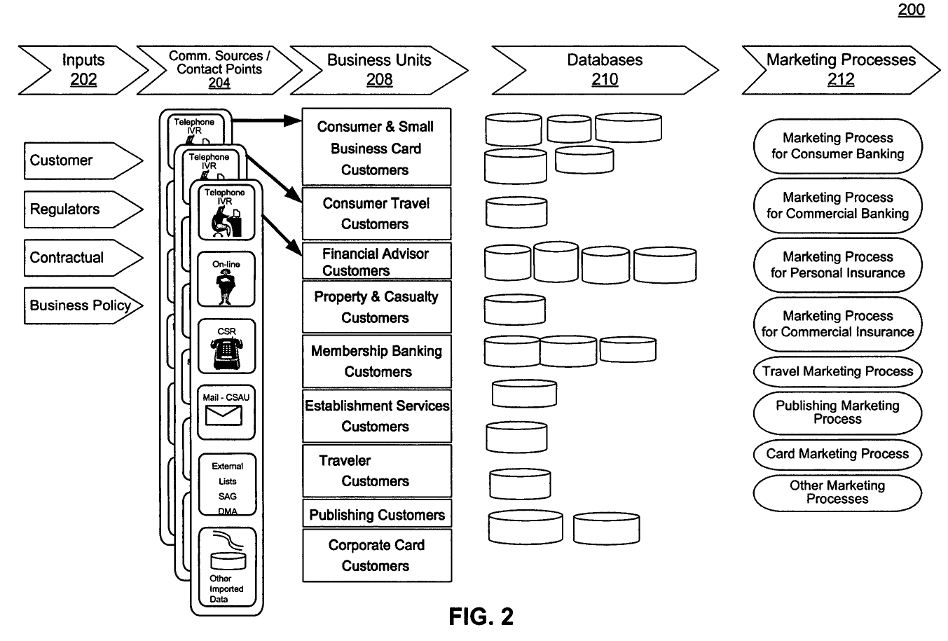

FIG. 2 is an example customer privacy and preferences system 200, including associated marketing processes, having multiple capture points, data stores, and marketing processes, where the distribution of customer preferences among multiple databases may result in a lack of integration for the capture of customer preferences, or a lack of consistency or reliability in respecting customer preferences, or a fragmented business contact experience for the customer, or all of the above.

In the system shown, inputs 202 are received via contact points 204, which also serve as communications sources for information storage 210. There may exist redundant contact points 204 corresponding to different exemplary business units 208. Inputs may be limitations on marketing implemented by the customer, regulators, contractual obligations, and/or business policy. Contact points/communication sources 204 can be any suitable communication means, for example and without limitation, a telephone network, intranet, the global, public Internet, a point of interaction device (e.g., a point of sale (POS) device, personal digital assistant (PDA), mobile telephone, kiosk, etc.), online communications, off-line communications, wireless communications, customer service representatives, mail, e-mail, facsimile, one or more external lists, and other external databases which may be imported via removable storage or network links, and/or the like.

Captured information is stored in a plurality of databases 210. Plurality of databases 210 can include, but is not limited to, one or more unconnected databases that may be used by different business units for varying purposes. Information from databases 210 can be used for one or more marketing departments and/or processes 212. In one example, when databases 210 are unconnected and nonuniform, different marketing departments and/or processes 212 may implement different consumer preferences based on the specific database accessed. In addition, because different databases 210 may be associated with different contact points 204 for the different business units 208, a customer 102 may have no alternative but to make contact with multiple contact points 204 in an attempt ensure that the customer's preferences are respected across the multiple business units. Even then, the fragmentation of the customer preference data across multiple databases 210 means that it may be difficult or impossible to assure completely consistent respect for customer preferences. Therefore, having a centralized customer privacy and preferences (“CP&P”) system may be more desirable.

The top of the FIG. 2 indicates a typical direction of flow for both customer preferences and data processing. This flow is only exemplary, however, since during marketing processes 212 customer preference data may be captured and stored in databases 210, in a direction reverse to the processing flow indicated.

### III. Consumer Privacy and Preferences with Centralized CP&P Data Store and CP&P Processing

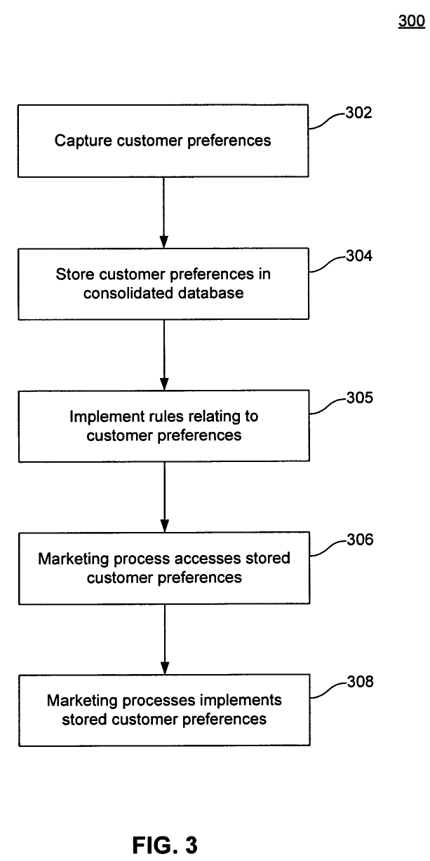

FIG. 3 is an example method and process 300 for implementing a customer privacy and preferences system according to the present invention. In step 302 customer preferences are captured via any of several means. In step 304, customer preferences are stored in a consolidated, centralized database. The centralized database provides an integrated customer-based opt-in/opt-out and preference mechanism, a choice of privacy options, a common point of storage, and one mechanism for transmission to multiple marketing execution systems.

In step 305 a set of rules, reflecting legal requirements or business policies related to customer privacy and preferences, or both, are used to modify customer preferences stored in the centralized database. In an example case, a company may have a policy that if a customer requests to not receive telemarketing phone calls on any one phone number associated with the customer, then the customer will not receive telemarketing phone calls on any other phone number associated with the customer, even if the customer has not specifically “opted-out” of marketing calls on those other numbers. If such a policy exists, then in step 305 the customer record in the centralized database may be modified to reflect that the customer should not receive marketing phone calls on any customer phone numbers.

In step 306, a marketing process accesses the stored customer information, validating or “scrubbing” all potential targets for the marketing campaign against the customer preference data stored in the centralized database, as described further below. In step 308, the marketing process implements the customer preferences stored in the centralized database.

The details of process 300 are explained further in exemplary embodiments of the present invention discussed below. The order of the steps shown in FIG. 3 is exemplary only, and does not limit the current invention. For example, in an embodiment of the invention step 305 could occur in conjunction with or following step 306 and/or step 308. Persons skilled in the relevant art(s) will also appreciate that collection of customer preferences 302, storing customer preferences 304, updating of the rules and regulations 305, accessing of customer preferences by marketing processes 306, and implementation of customer preferences in marketing processes 308 are typically though not necessarily ongoing activities which may be repeated over time, and which may occur in parallel in some cases.

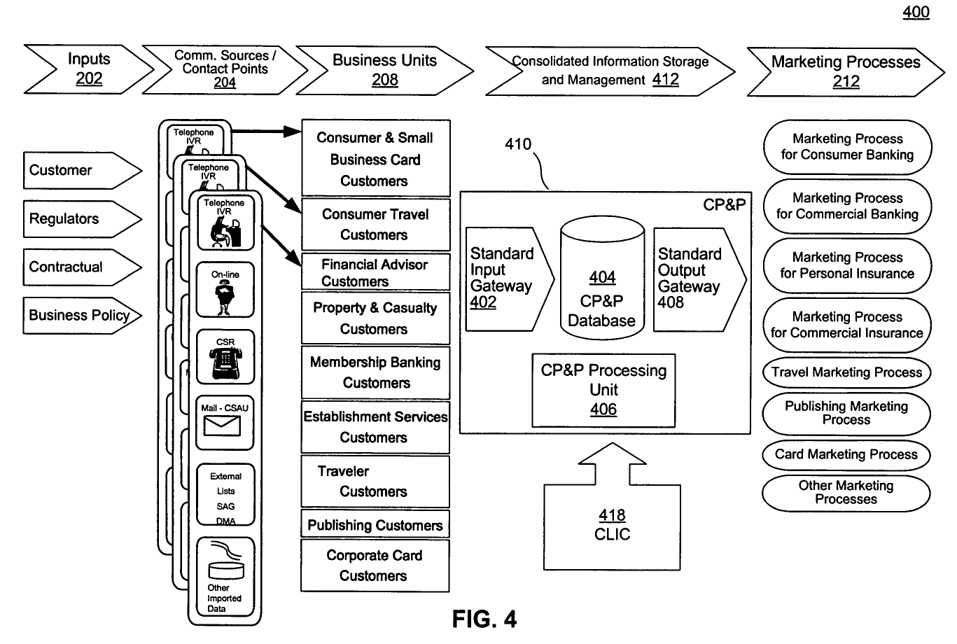

FIG. 4 is an example 400 of a CP&P system 410 having a consolidated, centralized database 404 integrated with all capture points 204 and across all associated marketing processes 212. Many aspects of FIG. 4 are shown in FIG. 2 and described above, and will not be repeated here. A main difference is that plurality of databases 210 are replaced with the consolidated, centralized database, shown here as the centralized CP&P database 404, along with associated CP&P processing unit 406. During step 304 (see FIG. 3), the captured customer preference information is entered into centralized CP&P database 404 through a standard input gateway 402. In one embodiment of the present invention, the CP&P system 410 is comprised of CP&P database 404, CP&P processing unit 406, standard input gateway 402, and standard output gateway 408. CP&P system 410 provides a consolidated customer preference information storage and management system 412.

Before initiating any marketing activity or marketing process, all potential targets are scrubbed against the CP&P database. The term “scrub” and its variants “scrubbed” and “scrubbing”, as used here and below, refers to a process or method wherein data from a first database is compared to data in a second database for purposes of data validation, data modification, and/or for purposes of modifying, changing, nullifying, limiting, adding, and/or redefining actions to be taken in relation to data in the first database.

In the present invention in particular, a database of customers who are potential marketing targets is scrubbed against the CP&P database by comparing the two databases. The scrubbing process ensures that the database of marketing targets reflects all privacy preferences and marketing preferences relevant to each customer, and further ensures that these customer preferences are in fact respected and implemented during the marketing process.

In one embodiment of the present invention, each business unit engaged in marketing activity, or each marketing process within the overall business enterprise, maintains its own database of customers who are potential targets for marketing activity. These unit-specific or marketing-process-specific customer databases are scrubbed against the CP&P database before any marketing activity or marketing process is executed. A standard output gateway 408 can be accessed by all business units or marketing processes for purposes of data scrubbing against the CP&P database.

In another embodiment of the present invention, consumer preference information, including privacy information, may be applied across all accounts held by a customer with a business by using customer linking identification capability (“CLIC”) system 418. CLIC system 418 links multiple accounts held by the same customer, wherein in one embodiment the CLIC system uses a unique, persistent customer identification number or similar unique persistent ID to link all of a customer's accounts. An exemplary CLIC system for use with the present invention is further described in U.S. Provisional Patent Application No. 60/722,038, filed Sep. 30, 2005, and titled “System and Method for Linking Customer Information,” which is incorporated by reference herein in its entirety, and in U.S. Patent Application No. to be assigned (Atty. Docket No. 2348.0510002), filed concurrently with the present application, and titled “Method, System, and Computer Program Product for Linking Customer Information,” which is incorporated by reference herein in its entirety.

Once the customer accounts are linked, the customer preferences may be applied across all the linked accounts. In step 306 (see FIG. 3) data from centralized CP&P database 404 is output through a standard output gateway 408 to be used during step 308 (see FIG. 3) by marketing departments and/or processes 212. In this manner, all marketing departments and/or processes 212 follow the same customer preferences.

In another embodiment of the present invention, described further below, a business utilizes a centralized marketing campaign management (MCM) system, which manages both workflow and marketing data for all data campaigns. The MCM system is linked to the CP&P database, and all business units engaged in marketing activities coordinate their marketing processes through the MCM system. In turn, the MCM system ensures that the customer preferences stored in the CP&P database are respected and implemented in the course of all marketing activities. In one embodiment of the present invention, the MCM system and the CLIC system together ensure that the customer preferences stored in the CP&P are respected and implemented in the course of all marketing activities.

Customer preference inputs accepted via customer contact points 204 may be limitations on marketing implemented by the customer 102 or by other sources, as already described above in conjunction with FIG. 2. Contact points/communication sources 204 can be any suitable communication means (e.g., a telephone network, the Internet, a POS device, etc.), again as described in more detail above in conjunction with FIG. 2.

In example 400, multiple customer contact points 204 correspond to different exemplary business units 208, and the customer contact points 204 are external to the CP&P system 410. In this embodiment, enterprise-wide consistency and completeness of customer preference data is ensured through the use of the standard input gateway 402, as described in more detail below.

In another embodiment of the present invention, customer contact points 204 for entering customer privacy preferences and other customer preferences may be integrated into CP&P system 410. For example, a single, common Web interface may be designed to capture all customer preferences. While different business units 208 may each employ their own unique Web interfaces for various customer sales, service, and related support options, all business units may integrate into their unique Web interfaces the single, common Web interface for capturing customer preferences.

In another example, a single, common telephone service and support script may be used to capture customer preferences. While different business units 208 may each employ their own telephone service systems for various customer sales, service, and support operations, all business units may integrate into their customer-oriented telephone services the single, common, enterprise-wide telephone script for capturing customer preferences. Similarly, the telephone service representatives for all business units may have access to a single, common in-house Web interface or other common in-house software interface for entering customer preferences accepted by phone.

Persons skilled in the relevant arts will recognize that other unified interfaces may be created for accepting customer preferences, and that other, well-known means may be employed to integrate those interfaces into all business units through an enterprise, even if those business units otherwise employ separate, discrete, and or non-integrated information processing systems, data input sources, user interfaces, and the like.

Although multiple customer contact points 204 may still exist, the use of the CP&P system 410 may result in a beneficial change in the experience of the customer 102. Because customer preferences captured through any one customer contact point 204 may now be shared among all business units 208 and all marketing processes 212, the customer 102 may no longer need to make contact with more than one of the multiple customer contact points 204. Instead, by contacting a single contact point 204 of a single business unit 208, the customer 102 may express all preferences, and these preferences will then be respected by all business units 208 and by all marketing processes 212.

Put another way, multiple customer contact points 204, including both different types of contact points 204 (e.g., phone, Web, mail, etc.) and/or separate contact points 204 for separate business units 208, may still be maintained for a variety of reasons, such as offering the customer 102 multiple options for how to contact the business or allowing each business unit to uniquely define certain aspects of its customer contact interaction. However, with the CP&P system 410 it may be the customer's 102 experience that only a single contact point 204 from among the multiple contact points 204 is actually needed to interact with the business, and it may further be the case that only a single episode of customer 102 contact with the single contact point 204 is required in order to capture all the of customer's preferences. This may result in a more convenient, less time-consuming, and generally more satisfactory customer experience, and therefore in improved customer relations. It may also result in cost savings for the business in terms of reduced staffing, reduced staff hours, or a reduction of other standard business costs associated with the customer contact points.

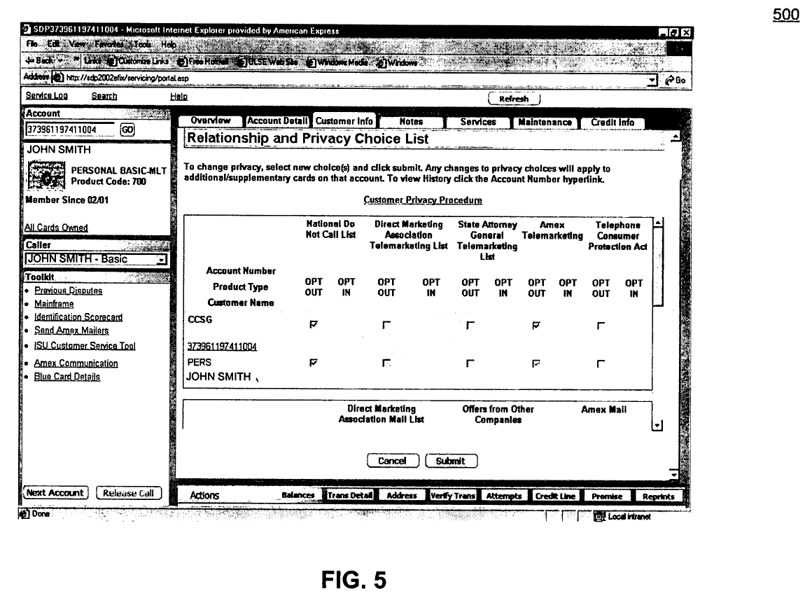

FIG. 5 is an illustration of an example interface 500 used for step 302 of FIG. 3, capturing customer privacy and preference information, according to an embodiment of the present invention. The interface 500 shown, which functions in a Web browser and is meant for use by a customer service representative, is representative only, and is not meant to limit the possible displays or interfaces which may be used in step 302. As will be appreciated by those skilled in the relevant art(s), many other interfaces for gathering customer preferences are possible, including but without limitation GUIs which do not run on a Web browser, GUIs which are directly accessible to the customer via the Web or other means, and automated systems for accepting customer preferences via a telephone. In addition, many other possible customer privacy and preferences may be accepted via the interface 500 in addition to those illustrated in FIG. 5.

In the example shown, a customer service representative may use the interface 500 to view and in some cases modify customer privacy preferences associated with an account such as a credit card account. Typically, the customer service representative will make changes based on requests received from the customer, where the requests may be received via a phone call, an e-mail, a letter sent via postal mail, a facsimile, or other forms of customer-to-business communication.

In an embodiment of the invention, only some privacy and marketing preferences may be changed by the customer service representative or even by the customer, via the interface 500. Some options, such as the customer preferences set via the National Do Not Call list or the State Attorney General Marketing list, must be established externally by the customer. They are imported into the CP&P database 404 via other sources, and are available for viewing only. These may be shown so that if the customer calls in, the customer service representative may inform the customer as to all of the customer's preferences, including those which are established by the customer externally to the business or enterprise and imported into the CP&P database.

In an embodiment of the present invention, opt-out privacy and opt-in privacy choices presented via interface 500 may include, for example and without limitation, telemarketing, direct mail, e-mail, restrictions on sharing personally identifying information with third parties, restrictions on sharing credit-related data with affiliates of the business, and sweepstakes offers.

Levels of granularity available with centralized CP&P database 404 include, for example and without limitation, an account issuer level (e.g., American Express Co. of New York, N.Y.), a line of business (e.g., credit card services, insurance services), a sub-line of business (e.g., consumer credit cards, business credit cards), a product grouping (e.g., charge, lending), and a subaccount (e.g., supplemental). Specific personal information which a customer may specify as being shared or not shared with third parties includes, for example and without limitation, a customer's name, a customer's address, a customer's phone number, a customer's social security number, a customer's date of birth, a customer's e-mail address, a customer's financial data, a customer's credit information, a customer's loan information, and a customer's purchase history. Specific marketing channels for which a consumer may opt in or opt out can be any suitable communication means, for example and without limitation, a telephone network, intranet, the global, public Internet, a point of interaction device (e.g., a point of sale (POS) device, personal digital assistant (PDA), mobile telephone, kiosk, etc.), online communications, off-line communications, wireless communications, customer service representative contacts, mail, e-mail, facsimile, one or more network links, and/or the like.

In an embodiment of the present invention, multiple contact points 204 with various interfaces 500 may be available to the consumer during step 302 of FIG. 3 for capturing customer preferences, including but without limitation calls to customer service representatives, calls to automated phone systems, e-mail contact, postal mail contact, facsimile, and Web interfaces. In addition, some customer preference inputs 202, such as preferences collected from government or other third-party databases, may use communications sources 204 which do not require a user interface 500. For example, a direct network link between an external database and the CP&P database may not require a user interface 500. However, no matter what type of contact point 204 or what interface 500, if any, may be used, step 302 employs standard input gateway 402 for capturing customer preferences.

In an embodiment, standard input gateway 402 provides for a common set of customer preferences data requirements across all possible inputs 302. These common data requirements ensure that consistent types of data, and all relevant types of data, are collected in step 302. The standard input gateway may also ensure that customer preference data can be transmitted to CP&P database 404 and can also be stored with consistent data structure and format in CP&P database 404.

In another embodiment of the present invention, standard input gateway 402 determines that customer preferences captured from a customer depend on whether the customer is a current customer, an applying customer, or a prospect or potential customer (i.e., a person with no prior relationship with the business, and who is being solicited to become a customer) of the business.

To establish the requirements for the data used to accept customer preferences, the standard input gateway 402 may have a protocol or set of protocols which may comprise, without limitation, either a set of rules that constrain the function of communications sources/contact points 204, or a standard or common interface or interfaces through which all input channels 202 communicate customer preferences to CP&P database 404, or both.

As an example, a business may offer customers the option to decide whether or not they may be contacted via e-mail with respect to marketing campaigns. When making this choice, the customer may be offered the option to opt-in or opt-out of e-mail contact for a single product or service, or to opt-in or opt-out of e-mail contact for all products and services across the enterprise. The protocol or protocols employed by standard input gateway 402 may ensure that the appropriate options reflecting these choices (e.g., opt-in/opt-out of e-mail for a single service or across the enterprise) are offered to the customer, this being true irrespective of the particular input source 202 used for inputting preference, and irrespective of the particular communications source or contact point 204 used to collect the preference, and irrespective of which interface 500, if any, is employed to collect the preference, and finally irrespective of which business unit 208 collects the preference.

Similarly, in an embodiment of the present invention standard input gateway 402 has a protocol or protocols to ensure or help ensure the integrity of the preference data transmitted to CP&P database 404. For example, the gateway may either require that the customer express a preference on specific privacy and contact choices, or possibly the gateway may provide default preference choices in the event that the customer does not make a selection among possible preferences. In another embodiment, when the customer has not made a preference selection, then instead of providing a default value the gateway may report that a preference selection was not made; suggested default preferences, a request for a preference, an alert that a preference was not expressed, or other responses to the lack of customer preference selection may then be implemented by logic within the CP&P processing unit 406, where these responses may be presented without limitation to the customer, to a customer service representative, to a database manager, or other parties associated with the business.

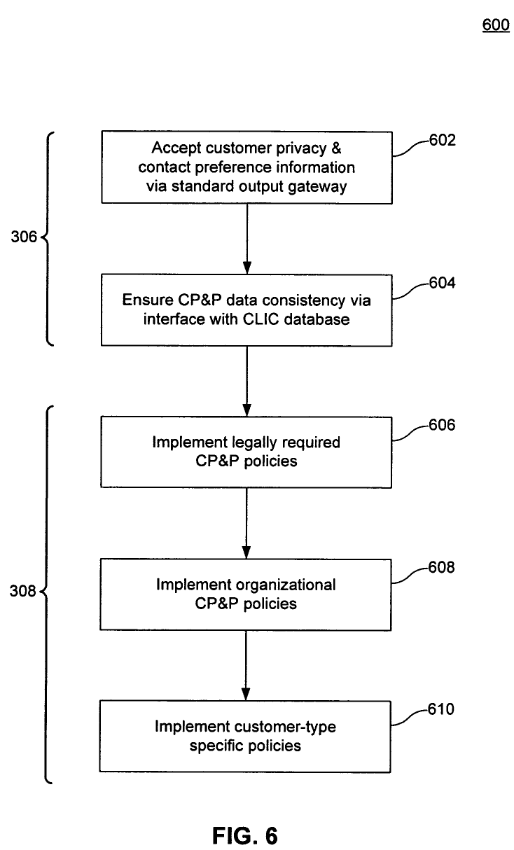

FIG. 6 is a flow chart of a method 600 illustrating how a marketing process 212 (see FIG. 2) can be integrated with the stored customer privacy and contact preference information in an embodiment of the present invention. A marketing process 212, as employed in one embodiment of the present invention, may include, for example and without limitation, generation of a mailing list and printed materials for a direct mail campaign, creation of a target database and call scripts for a telemarketing campaign, creation of a target mailing list and content for an e-mail campaign, and similar modes of consumer contact which are well known to persons skilled in the relevant art(s).

Steps 602 and 604 correspond to step 306 of FIG. 3 of the overall CP&P method, wherein a marketing process accesses customer preferences stored in the CP&P database. In step 602 the marketing process accepts customer privacy and preference information from the CP&P database 404 via a standard output gateway 408.

In one embodiment of the present invention, the standard output gateway 408 provides for a common set of customer preferences data requirements across all possible marketing processes 212. These common data requirements ensure that consistent types of data, and relevant types of data, are always collected in step 602. Put another way, the standard output gateway ensures that all marketing processes embody all of the pertinent customer preferences for privacy and customer contact. To establish the requirements for customer preferences, the standard output gateway 408 may have a protocol or set of protocols which comprise, for example and without limitation, either a set of preference data that a marketing process must accept, along with appropriate corresponding rules to process that data, or one or more standard interfaces through which all marketing processes 212 communicate with CP&P database 404, or both. The standard interface(s) may comprise, without limitation, either a user interface of the marketing process which conveys customer preference requirements to an employee of the business who is involved with the marketing process, or an automated process of the marketing process which automatically accepts the customer preference requirements.

The constraints placed on a marketing process by standard output gateway 408 may vary depending on the type of marketing process. For example, a marketing process 212 for a telemarketing campaign may interface with the standard output gateway 408 according to a different set of protocols than a marketing process 212 for a direct mail campaign.

Similarly, standard output gateway 408 may ensure or help to ensure the integrity of the preference data transmitted to a marketing process 212. For example, if a marketing process fails to collect a kind of data required to ensure that customer preferences are respected, the standard output gateway may set a flag or send an alert indicating a problem with the marketing process.

In step 604, in one embodiment of the present invention, a marketing process may complete the capture of customer preferences by scrubbing the preferences against the CLIC database 418. This scrubbing process would ensure that a set of customer preferences for one account is uniformly applied across all accounts owned by the customer. In the embodiment described here this scrubbing process would entail direct communication, not shown in FIG. 4, between the marketing process 212 and the CLIC database 418. In an alternative embodiment of the present invention, already described above, the scrubbing of the customer preferences against a consolidated database of customer identification information, such as the CLIC database 418, is performed in step 304 of FIG. 3 of the overall CP&P process, and therefore this step may not need to be repeated by the marketing process in step 604.

After accepting and possibly scrubbing customer preferences, in an embodiment of the present invention a marketing process may proceed with step 308 implementation of customer preferences of method 300 of FIG. 3. In the embodiment described here, step 308 is comprised of three steps 606, 608, and 610, which together implement both the customer preferences and also other rules, regulations, requirements, and policies relating to customer privacy and customer contact preferences.

To implement a preference, rule, regulation, requirement, or policy, hereafter referred to simply as a “preference or rule”, or the plural thereof, the marketing process must establish constraints which ensure that all preferences or rules are respected during the actual execution of the marketing campaign. In an embodiment of the invention, implementation of a preference or rule may entail, for example and without limitation, deleting a customer from a list of persons to be contacted, adding a customer to a list of persons to be contacted, adding a specific type of offer which will be made to a customer, deleting a specific type of offer which will be made to a customer, adding a channel through which a customer may be contacted, deleting a channel through which a customer may be contacted, deleting a customer from a list of customers whose information will be shared with other businesses or business units, adding a customer to a list of customers whose information will be shared with other businesses or business units, deleting some of the customer information which may be shared, or adding some of the customer information which may be shared. An offer which may be made to a customer or not made to a customer may comprise, for example and without limitation, a product, a service, or a campaign.

As a practical matter, implementation may include, for example and without limitation, setting one or more flags pertaining to a customer in a database, adding or deleting one or more records pertaining to a customer in a database, modifying one or more fields in a record pertaining to a customer in a database, or adding or deleting specific text, graphics, sound content, video content, or other information-bearing content. In turn, the information-bearing content may reside in media which includes, for example and without limitation, an e-mail, direct marketing printed matter, a Web page, a video, an automated phone message, or a call script to be used to market to a customer.

It will be apparent to persons skilled in the relevant art(s) that implementing customer privacy and contact preferences in a marketing campaign may entail other changes in marketing-related databases, marketing methods or processes, and/or in marketing content wherein the changes are contingent on factors which include, for example and without limitation, the type of the preferences to be implemented, the marketing channel(s) to be used, the content of the marketing campaign, and the software, hardware, and human activities or interventions required to execute the marketing campaign.

In step 606 the marketing process implements legally required policies for customer privacy and other preferences. Exemplary legal policies and constraints, such as Do-Not-Call lists, have already been discussed above.

In step 608, the marketing process implements organizational policies for customer privacy and preferences. It may be the case that some organizational policies apply across an entire organization, while other organizational policies are applied subject to various constraints which may include, for example and without limitation, only being applied for certain business units, or only being applied for certain kinds of accounts. For example, a credit card division of a financial company may have a policy that if a customer has requested to not be solicited concerning additional personal credit cards, then the customer will also not be solicited regarding possible business credit card accounts. On the other hand, an insurance division of the same financial company may have a policy that even if a customer has requested not to be solicited concerning additional kinds of personal insurance coverage, the customer may still be solicited regarding possible business insurance coverage.

In step 610, the marketing process implements customer-type specific policies. For example, there may be different policies for customers who purchase only consumer products and services compared to those customers who purchase business products and services.

The method 600 described above for implementing a marketing process as part of the CP&P method and system is exemplary only, and is not meant to limit the scope of the present invention. For example, in an alternative embodiment of method 600, there may be no organizational or customer-type specific policies to implement, in which case steps 608 and 610 are omitted altogether.

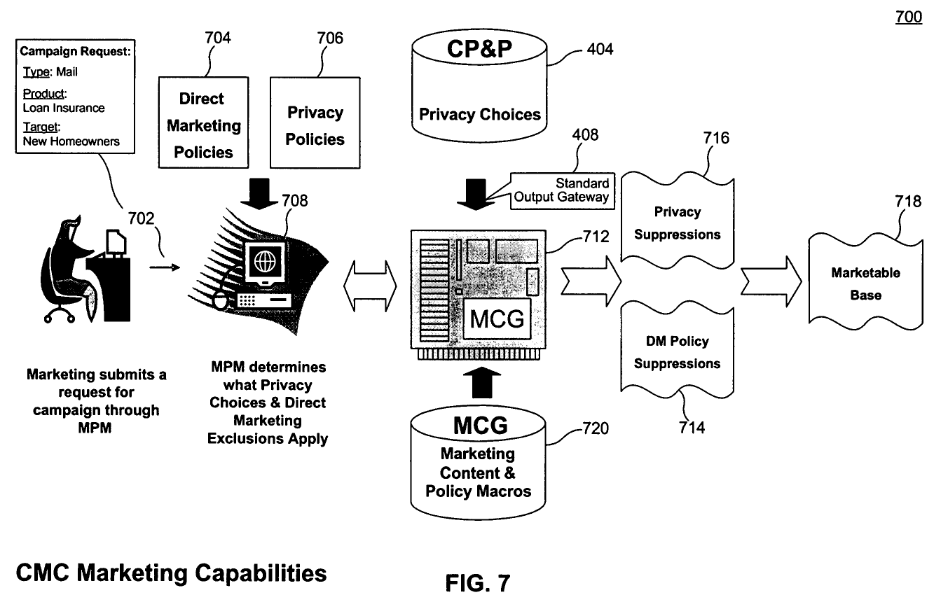

FIG. 7 is a block diagram of a exemplary marketing system 700 which, in an embodiment of the present invention, is integrated with a CP&P database. In the system shown, the exemplary centralized marketing campaign management (MCM) system discussed above has two components, a marketing project management (MPM) system 708 and a marketing campaign generation (MCG) system 712.

A staff member in a marketing department submits to MPM system 708 a request 702 to initiate a marketing campaign. The request 702 may include, for example and without limitation, a type of campaign, such as direct mail or telemarketing; a target group of customers, such as consumer credit card customers or business loan customers; a type of product, such as a new credit card, a new type of loan, or possibly insurance on credit card debt or loan debt; and other parameters which specify some or all of the content, target audience, communications channel, or other factors pertaining to the execution of the marketing campaign.

MPM system 708 accepts this request 702 from the marketing department, and may also accept policy related information such as direct marketing policies 704, privacy policies 706, and other policies (not shown). While system 700 is depicted as storing policies 704 and 706 apart from the CP&P database 404, this represents only one possible embodiment of the current invention. In another embodiment, part or all of the policy related rules or data may be stored with customer preference data in CP&P database 404, or may be embodied in one or more rule sets which are integral to CP&P processing unit 406 (see FIG. 4).

In the embodiment shown in system 700, MPM system 708 uses the marketing request 702 and the policies 704 and 706 to determine the privacy choices and marketing exclusions that will apply to the current marketing campaign. MPM system 708 then hands off these constraints to MCG system 712, which will actually generate the marketing campaign. MCG system 712 also obtains marketing content from a database 720. Also, in step 602 of method 600, MCG system 712 receives privacy choices and contact preferences for specific customers from CP&P database 404 via the standard output gateway 408.

In an implementation of steps 606, 608, and 610 of FIG. 6, based on all the data received, MCG system 712 determines both privacy suppressions 716 and direct marketing policy suppressions 714, which together determine which potential target customers for the campaign should be excluded as actual targets. Note that step 604 of FIG. 6, wherein CP&P database 404 consistency is ensured via an interface with CLIC database 418, is not directly embodied in exemplary system 700. In an alternative embodiment, preference data consistency may be implemented through a connection between CLIC database 418 and CP&P database 404, as shown in FIG. 4, or through a connection between CLIC database 418 and MCG system 712.

MCG system 712 may also determine other constraints on the content of the marketing campaign, where the constraints may apply to some or all customers. The final result is a list of the marketable base 718, i.e., the customers who may be approached as part of the marketing campaign, along with any constraints on contact channel or content for specific customers. Not shown is the actual marketing content, which may also be generated in part or in whole by MCG system 712.

Persons skilled in the relevant art(s) will appreciate that while MCG system 712 is depicted as a device such as a data processing system, some aspects of the system, such as generating suitable voice content or video images, may require human intervention and/or additional technologies not shown. Persons skilled in the relevant art(s) will further appreciate that the system 700 depicted is exemplary only, and that the relevant steps of method 300 and method 600 may be performed by alternative embodiments, wherein different elements of the system perform differently from the system 700 shown. For example, in an alternative embodiment, the implementation of policies 704 and 706 may be made by software associated with the CP&P database 404 rather than by software associated with the MPM system 708.

### IV. Summary

The centralized CP&P system 410 provides an enhanced customer experience and an expanded, more manageable marketable universe, while being fully compliant with both legal requirements for customer privacy and preferences and with the preferences voiced by the customers themselves. This leads to brand protection and enhancement with cost savings and revenue gain for businesses.

An integrated analysis and reporting capability (not illustrated) may enable information to be leveraged to address and guide the regulatory environment, as well as to influence strategy and planning for future marketing campaigns. Analyses and reports may indicate the population of customers who have opted in on an offer or opted out of an offer, the population of customers who have opted in on a channel or out on a channel, and other similar reports, possibly categorized by marketing channels, types of customers, types of offers or services, and other factors.

Centralized CP&P system 410 may provide an expanded marketing universe for the account issuer, as it allows more accurate and specific application of policy changes. This results in a larger eligible group of customers to be marketed. For example, the increased flexibility and integrated rules application enable privacy choices to be applied to a subset of business units or departments. By applying the choice to the subset of business units or departments, the exact application of the option requested by the customer is allowed instead of requiring a broad application across all customer relationships.

Centralized CP&P system 410 may also allow for quick response to privacy legislation, such as the integration of the national Do Not Call Registry. Removing all affected customers from a business marketing scheme could significantly impact that marketing channel. In previous systems, for example, only one telemarketing opt-out was available, which did not allow differentiating between the sources of the opt-out. With centralized CP&P system 410, however, there are multiple telemarketing opt-out flags that provide the intelligence to customize policy based on each source.

In another example, due to centralized CP&P system 410, a cycle time to capture and implement customer policy choice can be reduced from previous systems.

### V. Example Implementations

The present invention, as typically embodied in method 300, method 600, system 400, and system 700, or as implemented in alternate embodiments, or any part(s) or function(s) thereof, may be implemented using hardware, software, and human operator input and decision making, or a combination thereof, and may be implemented in part or in whole by one or more computer systems or other processing systems.

The manipulations performed by the present invention were often referred to in terms, such as adding, comparing, implementing, or respecting, which are commonly associated with mental operations performed by a human operator. While, as indicated above, the intervention of a human operator may play a role in inputting customer preferences or in related processing as required by the present invention, such intervention of a human operator is only necessary in some embodiments of the present invention and not others. In most cases, most and possibly all of the operations described herein which form part of the present invention are performed without the intervention of a human operator. Rather, the operations are machine operations. Useful machines for performing the operation of the present invention include general purpose digital computers or similar devices.

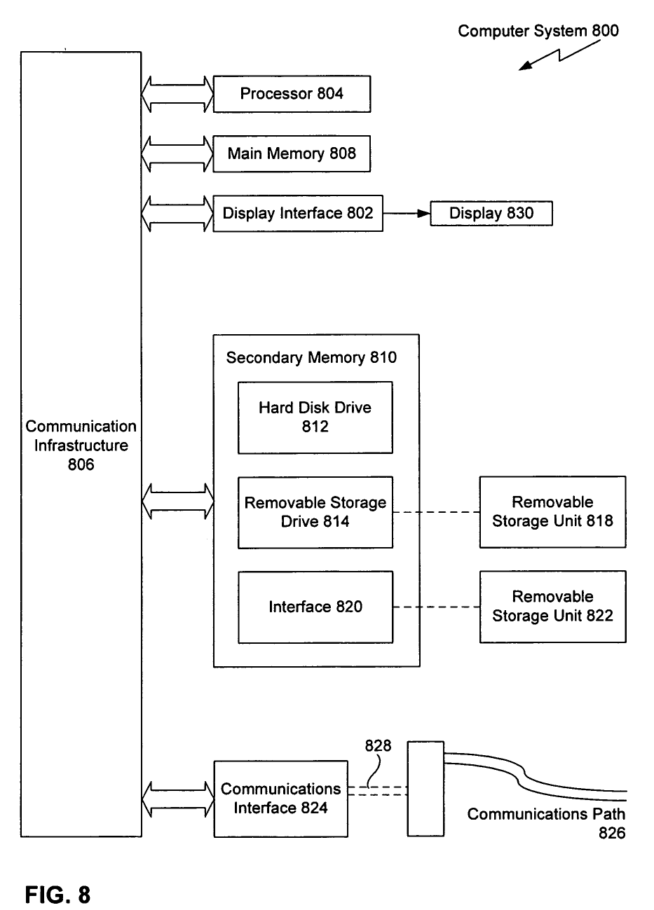

In one embodiment, the invention is directed toward one or more computer systems capable of carrying out the functionality described herein. An example of a computer system 800 is shown in FIG. 8.

The computer system 800 includes one or more processors, such as processor 804. The processor 804 is connected to a communication infrastructure 806 (e.g., a communications bus, cross over bar, or network). Various software embodiments are described in terms of this exemplary computer system. After reading this description, it will become apparent to a person skilled in the relevant art(s) how to implement the invention using other computer systems and/or architectures.

Computer system 800 can include a display interface 802 that forwards graphics, text, and other data from the communication infrastructure 806 (or from a frame buffer not shown) for display on the display unit 830.

Computer system 800 also includes a main memory 808, preferably random access memory (RAM), and may also include a secondary memory 810. The secondary memory 810 may include, for example, a hard disk drive 812 and/or a removable storage drive 814, representing a floppy disk drive, a magnetic tape drive, an optical disk drive, etc. The removable storage drive 814 reads from and/or writes to a removable storage unit 818 in a well known manner. Removable storage unit 818 represents a floppy disk, magnetic tape, optical disk, etc. which is read by and written to by removable storage drive 814. As will be appreciated, the removable storage unit 818 includes a computer usable storage medium having stored therein computer software and/or data.

In alternative embodiments, secondary memory 810 may include other similar devices for allowing computer programs or other instructions to be loaded into computer system 800. Such devices may include, for example, a removable storage unit 822 and an interface 820. Examples of such may include a program cartridge and cartridge interface (such as that found in video game devices), a removable memory chip (such as an erasable programmable read only memory (EPROM), or programmable read only memory (PROM)) and associated socket, and other removable storage units 822 and interfaces 820, which allow software and data to be transferred from the removable storage unit 822 to computer system 800.

Computer system 800 may also include a communications interface 824. Communications interface 824 allows software and data to be transferred between computer system 800 and external devices. Examples of communications interface 824 may include a modem, a network interface (such as an Ethernet card), a communications port, a Personal Computer Memory Card International Association (PCMCIA) slot and card, etc. Software and data transferred via communications interface 824 are in the form of signals 828 which may be electronic, electromagnetic, optical or other signals capable of being received by communications interface 824. These signals 828 are provided to communications interface 824 via a communications path (e.g., channel) 826. This channel 826 carries signals 828 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 814, a hard disk installed in hard disk drive 812, and signals 828. These computer program products provide software to computer system 800. The invention is directed to such computer program products.

Computer programs (also referred to as “computer control logic”, “logic”, or “processing”, e.g., “CP&P processing”) are stored in main memory 808 and/or secondary memory 810. Computer programs may also be received via communications interface 824. Such computer programs, when executed, enable the computer system 800 to perform the features of the present invention, as discussed herein. In particular, the computer programs, when executed, enable the processor 804 to perform the features of the present invention. Accordingly, such computer programs represent controllers of the computer system 800.

In an embodiment where the invention is implemented using software, the software may be stored in a computer program product and loaded into computer system 800 using removable storage drive 814, hard drive 812 or communications interface 824. The control logic (software), when executed by the processor 804, causes the processor 804 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### VI. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for ensuring compliance with a customer preference for the use of personal information by an enterprise having a plurality of business units, comprising:
capturing the customer preference through one of the plurality of business units;
storing the customer preference in a centralized database, wherein the centralized database is accessible to each of the plurality of business units; and
providing each business unit with access to the stored customer preference to allow each business unit to validate a marketing process of the respective business unit in view of the customer preference.

2. The method of claim 1, wherein the capturing step comprises:
capturing the input of the customer preference via a customer preference user interface, wherein the customer preference user interface connects to the centralized database via an input gateway.

3. The method of claim 2, wherein the customer preference user interface comprises at least one of a Web interface accessible to a customer service representative of the one or more business units, a Web interface accessible to the customer, or a phone interface accessible to the customer.

4. The method of claim 1, wherein the capturing step comprises:
capturing the customer preference via at least one of an e-mail communication from the customer, a postal mail communication from the customer, or a phone conversation between the customer and a customer service representative of the business unit.

5. The method of claim 1, wherein the capturing step comprises:
capturing the customer preference from an existing source of customer preferences, wherein the existing source of customer preferences comprises at least one of an existing database of customer preferences maintained by the business unit or an existing external database of customer preferences.

6. The method of claim 1, wherein the customer preference comprises at least one of a preference for a set of data that may be collected about the customer, a preference for a set of data that may not be collected about the customer, a preference for how the collected data may be used, a preference for how the collected data may not be used, a preference for a type of marketing the customer may receive, a preference for a type of marketing the customer may not receive, a preference for a type of information about the customer which may be shared between business units, a preference for a type of information about the customer which may not be shared between business units, a preference for a type of information about the customer which may be shared externally, or a preference for a type of information about the customer which may not be shared externally.

7. The method of claim 1, wherein the customer preference comprises at least one of a channel through which the customer may be contacted, a channel through which the customer may not be contacted, a business unit which may contact the customer, a business unit which may not contact the customer, a third-party marketing partner which may contact the customer, a third-party marketing partner which may not contact the customer, a type of offer which may be made to the customer, or a type of offer which may not be made to the customer, wherein the offer comprises at least one of a product, a service, or a campaign.

8. The method of claim 1, wherein the customer comprises at least one of a current customer of the business unit or a potential customer of the business unit.

9. The method of claim 1, wherein the customer preference is based on at least one of the customer, a legal regulation, a contract, or a business policy.

10. The method of claim 1, further comprising analyzing and modifying the customer preference based on a set of rules.

11. The method of claim 10, further comprising providing the customer with a choice as to which rule from the set of rules will be applied to the customer preference.

12. The method of claim 10, further comprising providing the business unit with a choice as to which rule from the set of rules will be applied to the customer preference.

13. The method of claim 1, wherein the step of providing each business unit with access to the stored customer preference comprises providing an output gateway of the centralized database, wherein each business unit may access the customer preference via the output gateway, and wherein the output gateway comprises at least one of a user interface linking the centralized database and the marketing process of the respective business unit, an automated process linking the centralized database and the marketing process of the respective business unit, or a set of protocols defining an interface between the centralized database and the marketing process of the respective business unit.

14. The method of claim 1, wherein the centralized database constrains the marketing process with respect to at least one of a type of offer made to the customer, a type of campaign presented to the customer, or a channel by which to contact the customer.

15. The method of claim 1, further comprising validating the marketing process of the respective business unit in view of the customer preference, wherein validating comprises:
comparing a list of marketing targets of the marketing process against the customer preference in the centralized database, and
implementing the customer preference for the customer in the list of marketing targets.

16. A system for ensuring compliance with a customer preference for the use of personal information by an enterprise having a plurality of business units, comprising:
a processor; and
a memory in communication with the processor, the memory storing a plurality of processing instructions for directing the processor to:
capture the customer preference through one of the plurality of business units;
store the customer preference in a centralized database, wherein the centralized database is accessible to each of the plurality of business units; and
provide each business unit with access to the stored customer preference to allow each business unit to validate a marketing process of the respective business unit in view of the customer preference.

17. The system of claim 16, wherein the instructions to capture the customer preference through one of the plurality of business units further comprise instructions for directing the processor to capture the input of a customer preference data via a customer preference user interface, wherein the customer preference user interface connects to the centralized database via an input gateway.

18. The method of claim 17, wherein the customer preference user interface comprises at least one of a Web interface accessible to a customer service representative of the one or more business units, a Web interface accessible to the customer, or a phone interface accessible to the customer.

19. The system of claim 16, wherein the instructions to capture the customer preference through one of the plurality of business units further comprise instructions for directing the processor to capture the customer preference via the input of a customer preference data which has been received via at least one of an e-mail communication from the customer, a postal mail communication from the customer, or a phone conversation between the customer and a customer service representative of the business unit.

20. The system of claim 16, wherein the instructions to capture the customer preference through one of the plurality of business units further comprise instructions for directing the processor to capture the customer preference from an existing source of customer preferences, wherein the existing source of customer preferences comprises at least one of an existing database of customer preferences maintained by the business unit or an existing external database of customer preferences.

21. The system of claim 16, wherein the customer preference comprises at least one of a preference for a set of data that may be collected about the customer, a preference for a set of data that may not be collected about the customer, a preference for how the collected data may be used, a preference for how the collected data may not be used, a preference for a type of marketing the customer may receive, a preference for a type of marketing the customer may not receive, a preference for a type of information about the customer which may be shared between business units, a preference for a type of information about the customer which may not be shared between business units, a preference for a type of information about the customer which may be shared externally, or a preference for a type of information about the customer which may not be shared externally.

22. The system of claim 16, wherein the customer preference comprises at least one of a channel through which the customer may be contacted, a channel through which the customer may not be contacted, a business unit which may contact the customer, a business unit which may not contact the customer, a third-party marketing partner which may contact the customer, a third-party marketing partner which may not contact the customer, a type of offer which may be made to the customer, or a type of offer which may not be made to the customer, wherein the offer comprises at least one of a product, a service, or a campaign.

23. The system of claim 16, wherein the customer comprises at least one of a current customer of the business unit or a potential customer of the business unit.

24. The system of claim 16, wherein the customer preference is based on at least one of the customer, a legal regulation, a contract, or a business policy.

25. The system of claim 16, further comprising instructions for directing the processor to analyze and modify the customer preference based on a set of rules.

26. The system of claim 25, further comprising instructions for directing the processor to provide the customer with a choice as to which rule from the set of rules will be applied to the customer preference.

27. The system of claim 25, further comprising instructions for directing the processor to provide the business unit with a choice as to which rule from the set of rules will be applied to the customer preference.

28. The system of claim 16, wherein the instructions to provide each business unit with access to the stored customer preference to allow each business unit to validate a marketing process of the respective business unit in view of the customer preference comprises instructions for directing the processor to provide an output gateway of the centralized database, wherein each business unit may access the customer preference via the output gateway, and wherein the output gateway comprises at least one of a user interface linking the centralized database and the marketing process of the respective business unit, an automated process linking the centralized database and the marketing process of the respective business unit, or a set of protocols defining an interface between the centralized database and the marketing process of the respective business unit.

29. The system of claim 16, further comprising instructions for directing the processor to constrain the marketing process with respect to at least one of a type of offer made to the customer, a type of campaign presented to the customer, or a channel by which to contact the customer, wherein said instructions constrain the marketing process based on data in the centralized database.

30. The system of claim 16, further comprising instructions for directing the processor to validate the marketing process of the respective business unit in view of the customer preference, wherein said instructions comprise instructions for directing the processor to:
compare a list of marketing targets of the marketing process against the customer preference in the centralized database, and
implement the customer preference for the customer in the list of marketing targets.

31. A computer program product comprising a computer usable medium having control logic stored therein for causing a computer to ensure compliance with a customer preference for the use of personal information by an enterprise having a plurality of business units, said control logic comprising:
first computer readable program code means for causing the computer to capture the customer preference through one of the plurality of business units;
second computer readable program code means for causing the computer to store the customer preference in a centralized database, wherein the centralized database is accessible to each of the plurality of business units; and
third computer readable program code means for causing the computer to provide each business unit with access to the stored customer preference to allow each business unit to validate a marketing process of the respective business unit in view of the customer preference.

32. The computer program product of claim 31, wherein said first computer readable program code means further comprises:
fourth computer readable program code means for causing the computer to capture the input of the customer preference via a customer preference user interface, wherein the customer preference user interface connects to the centralized database via an input gateway.

33. The computer program product of claim 31, wherein the customer preference user interface comprises at least one of a Web interface accessible to a customer service representative of the one or more business units, a Web interface accessible to the customer, or a phone interface accessible to the customer.

34. The computer program product of claim 31, wherein said computer readable program code means further comprises:
fifth computer readable program code means for causing the computer to capture the customer preference via the input of a customer preference data which has been received via at least one of an e-mail communication from the customer, a postal mail communication from the customer, or a phone conversation between the customer and a customer service representative of the business unit.

35. The computer program product of claim 31, wherein said first computer readable program code means further comprises:
sixth computer readable program code means for causing the computer to capture the customer preference from an existing source of customer preferences, wherein the existing source of customer preferences comprises at least one of an existing database of customer preferences maintained by the business unit or an existing external database of customer preferences.

36. The computer program product of claim 31, wherein the customer preference comprises at least one of a preference for a set of data that may be collected about the customer, a preference for a set of data that may not be collected about the customer, a preference for how the collected data may be used, a preference for how the collected data may not be used, a preference for a type of marketing the customer may receive, a preference for a type of marketing the customer may not receive, a preference for a type of information about the customer which may be shared between business units, a preference for a type of information about the customer which may not be shared between business units, a preference for a type of information about the customer which may be shared externally, or a preference for a type of information about the customer which may not be shared externally.

37. The computer program product of claim 31, wherein the customer preference comprises at least one of a channel through which the customer may be contacted, a channel through which the customer may not be contacted, a business unit which may contact the customer, a business unit which may not contact the customer, a third-party marketing partner which may contact the customer, a third-party marketing partner which may not contact the customer, a type of offer which may be made to the customer, or a type of offer which may not be made to the customer, wherein the offer comprises at least one of a product, a service, or a campaign.

38. The computer program product of claim 31, wherein the customer comprises at least one of a current customer of the business unit or a potential customer of the business unit.

39. The computer program product of claim 31, wherein the customer preference is based on at least one of the customer, a legal regulation, a contract, or a business policy.

40. The computer program product of claim 31, wherein said computer readable program code means further comprises:
seventh computer readable program code means for causing the computer to analyze and modify the customer preference based on a set of rules.

41. The computer program product of claim 40, further comprising computer readable program code means for causing the computer to allow the customer to choose which rule from the set of rules will be applied to the customer preference.

42. The computer program product of claim 40, further comprising computer readable program code means for causing the computer to allow the business unit to choose which rule from the set of rules will be applied to the customer preference.

43. The computer program product of claim 31, wherein said third computer readable program code means further comprises:
eighth computer readable program code means for causing the computer to provide an output gateway of the centralized database, wherein each business unit may access the customer preference via the output gateway, and wherein the output gateway comprises at least one of a user interface linking the centralized database and the marketing process, an automated process linking the centralized database and the marketing process, or a set of protocols defining an interface between the centralized database and the marketing process

44. The computer program product of claim 31, wherein said computer readable program code means further comprises:
ninth computer readable program code means for causing the computer to constrain the marketing process with respect to at least one of a type of offer made to the customer, a type of campaign presented to the customer, or a channel by which to contact the customer, wherein said ninth computer readable program code means constrain the marketing process based on data in the centralized database.

45. The computer program product of claim 31, further comprising
tenth computer readable program code means for causing the computer to validate the marketing process of the respective business unit in view of the customer preference, wherein said tenth computer readable program code comprises:
eleventh computer readable program code means for causing the computer to compare a list of marketing targets of the marketing process against the customer preference in the centralized database, and
twelfth computer readable program code means for causing the computer to implement the customer preference for the customer in the list of marketing targets.
